(19) United States
(12) Patent Application Publication
(10) Pub. No.: US 2005/0202113 A1
(43) Pub. Date: Sep. 15, 2005

(54) Web bonded plastic sheet extruding system

(76) Inventor: Cheng-Te Chi, Feng Yuan City (TW)

Correspondence Address: LEONG C LEI, PMB # 1008, 1867 YGNACIO VALLEY ROAD, WALNUT CREEK, CA, 94598, US

(21) Appl. No.: 10/796,074

(22) Filed: Mar. 10, 2004

(51) Int. Cl. B29C 47/06; B29C 47/14

(52) U.S. Cl. 425/133.5; 425/327

(57) ABSTRACT

A web bonded plastic sheet extruding system to provide a fast and economic benefits compliance production of comfortable and duration mid sole for shoes by having two extruders adapted to a heating die and to respectively deliver thermoplastic materials of different densities through the heating guide pipes; two shaft rods provided in front of a roll compressor to respectively take up an upper web and a lower web and bond webs on the plastic materials by infusion through the roller unit into a web bonded plastic sheet combined with a higher density and a lower density.

### BACKGROUND OF THE INVENTION

(a) Technical Field of the Invention

The present invention is related to a extruding system for the production of web bonded plastic sheet, and more particularly, to one that has its heating die adapted with two extruders for respectively delivering plastic materials of different densities, and an upper and lower shaft rods mounted to the front of the roller for the higher density and the lower density plastic materials to respectively be bonded with the upper web and the lower web.

(b) Description of the Prior Art

As illustrated in FIGS. 1 and 2 of the accompanying drawings, the structure of a web bonded plastic sheet extruding system of the prior art relates to an extruder (12) is adapted in series to the front of a heating die (11). Plastic material is delivered through a heating guide pipe (13) into the rollers (14) of a roll compressor (16) to be compressed into a plastic sheet (17) and transorted backward through a guide roller (16). As mid soles cut from the plastic sheet is of the same density and hardness, it fails to distinguish the different flexure strength between the palm and the heel parts; furthermore, if the application of glue on the back of the plastic sheet (17) for the bonding of a web layer, the process could be troublesome, time consuming and result in higher production cost since it takes another roll compressor to level the plastic sheet bonded with the web layer. Higher investment and process cost make the prior art failing the current requirements, and losing its competitive strength.

### SUMMARY OF THE INVENTION

The primary purpose of the present invention is to provide an extruding system for the production of web bonded plastic sheet in bi-density construction to serve the basic material for the most comfortable and duration mid sole of shoes. To achieve the purpose, two extruders are connected to a heating die to respectively deliver thermoplastic materials of different densities through their respective heating guide pipes into the heating die, then rolled and infused by the rolling compressor into the plastic sheet.

Another purpose of the present invention is to provide an extruding system for the production of web bonded plastic sheet in an integrated process to form the plastic sheet faced with web. To achieve the purpose, two shaft rods are respectively pivoted to the front of the rolling compressor to take up upper web and lower web and bond the webs to both sides of the higher density and the lower density plastic materials in melting status through the rolling compressor into the plastic sheet faced on both sides with a web layer.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structaral embodiment incorporating the principles of the present invention is shown by way of illustrative example.

### BRIEF DESCRIPTION OF THE DRAWINGS

FIG. 1 is a perspective view of an extruding system of the prior art.

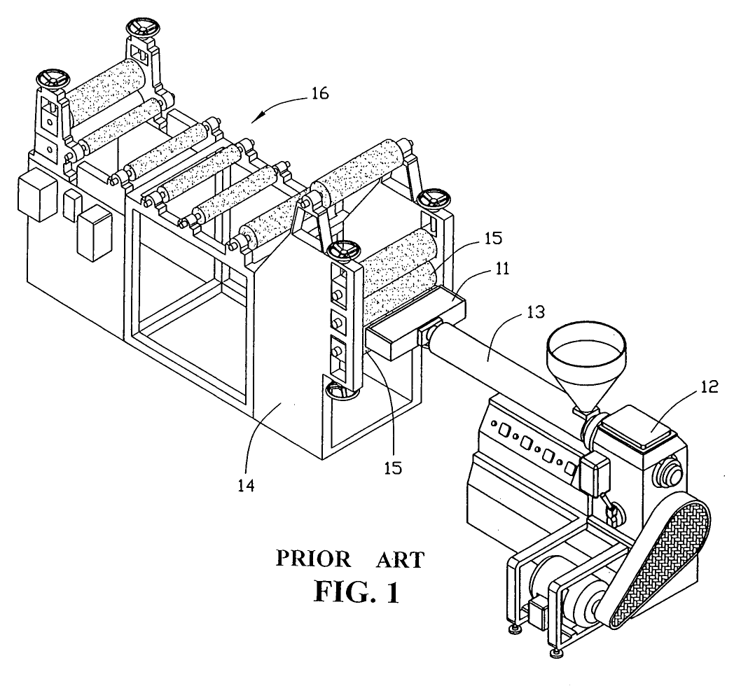

FIG. 2 is a side view of a preferred embodiment of the prior art.

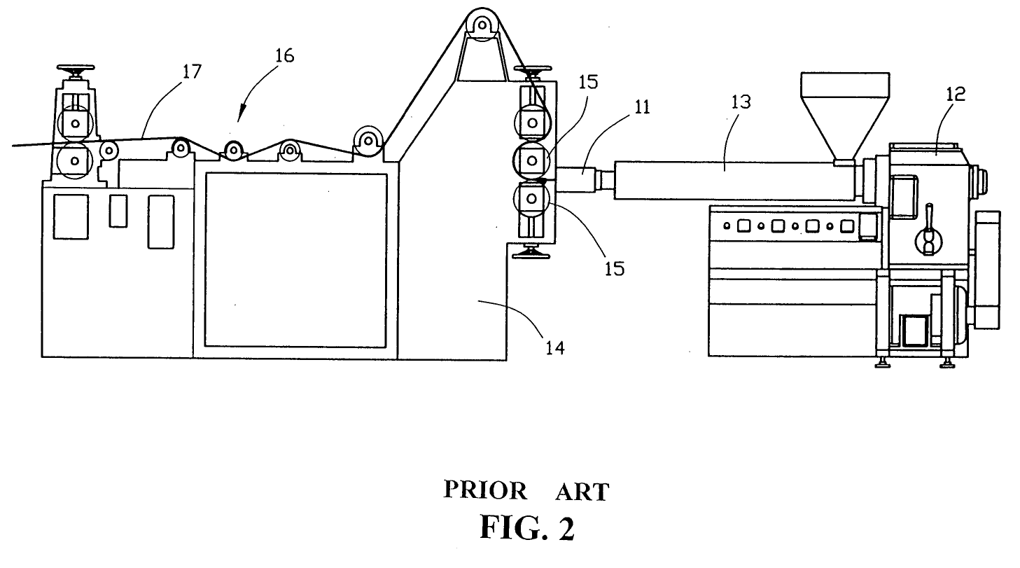

FIG. 3 is a perspective view of the present invention.

FIG. 4 is a side view of a first preferred embodiment of the present invention.

FIG. 5 is a magnified view of a cross section of a finished product processed using the present invention.

FIG. 6 is a perspective view of a second preferred embodiment of the present invention.

FIG. 7 is a perspective view of a third preferred embodiment of the present invention.

FIG. 8 is a perspective view of a fourth preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

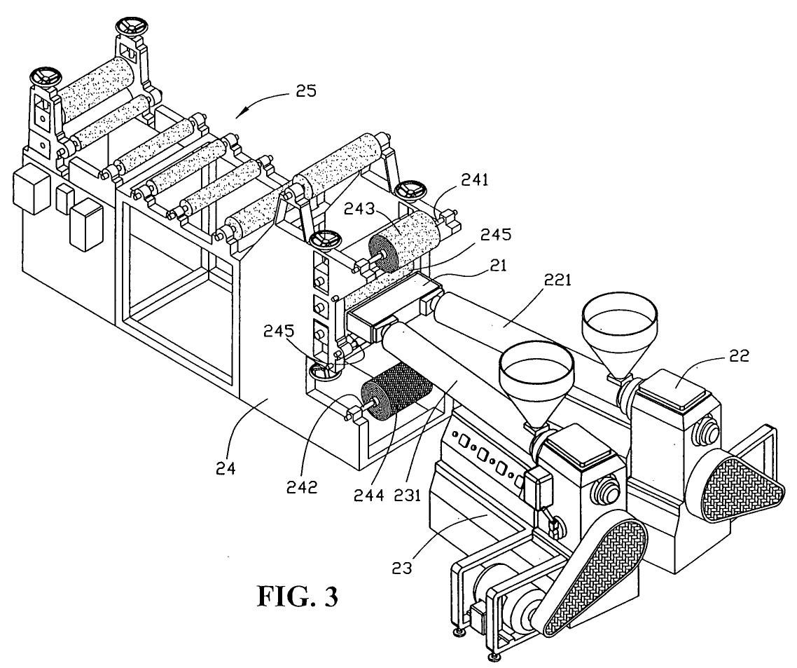

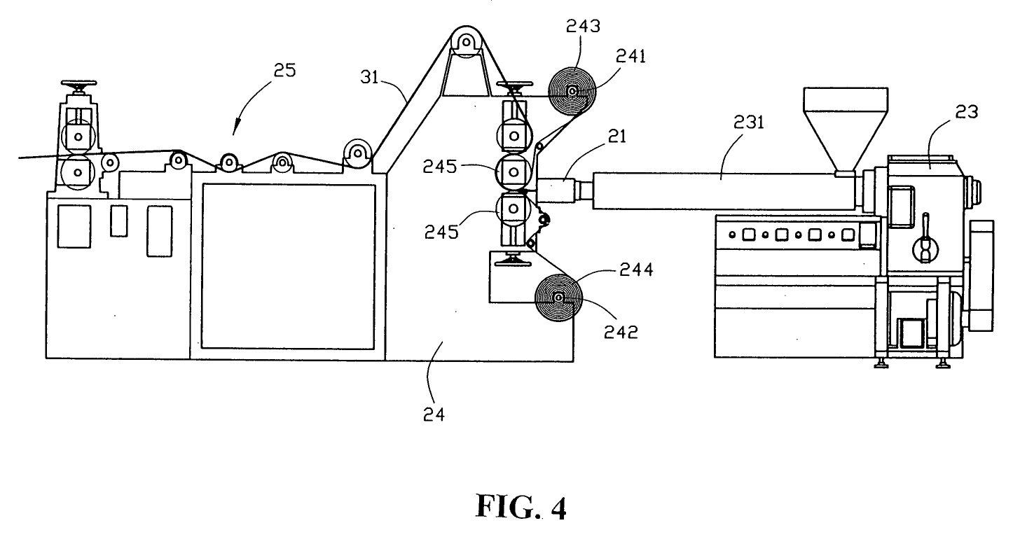

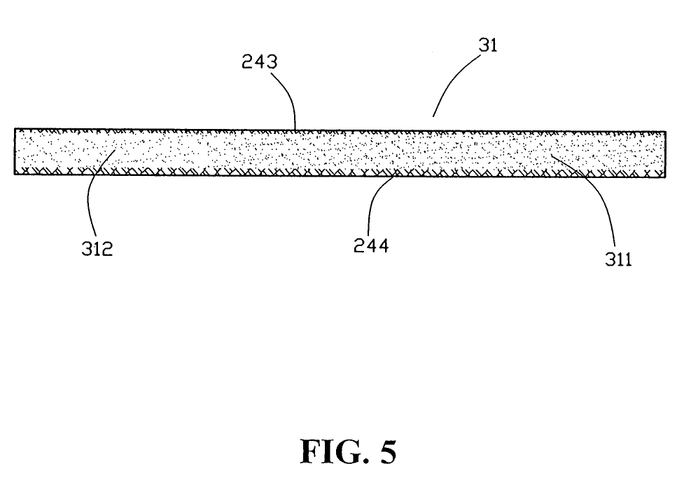

Referring to FIGS. 3, 4, and 5 for a first preferred embodiment of the present invention, a first extruder (22) and a second extruder (23) are fixed to the front of a heating die (21) to deliver thermoplastic materials of different densities through their respective heating guide pipes (221) (231) into the heating die (21) at the same time. An upper shaft rod (241) and a lower shaft rod (242) are respectively pivoted to the front of a rolling compressor (24) to bond an upper web (243) and a lower web (244) to the higher density and the lower density plastic materials in melting status inside the heating die (21), and then compressed through a roller (245) of the rolling compressor (24) into a plastic sheet (31) to be transported backwards by multiple guide rolls (25). The finished product of the plastic sheet (31) is of bi-density construction combined with the higher density (311) and lower density (312) plastic materials. The present invention provides an easy, fast and integrated process that meets economic benefits to produce the plastic sheet for cutting into comfortable and duration mid soles in shoes.

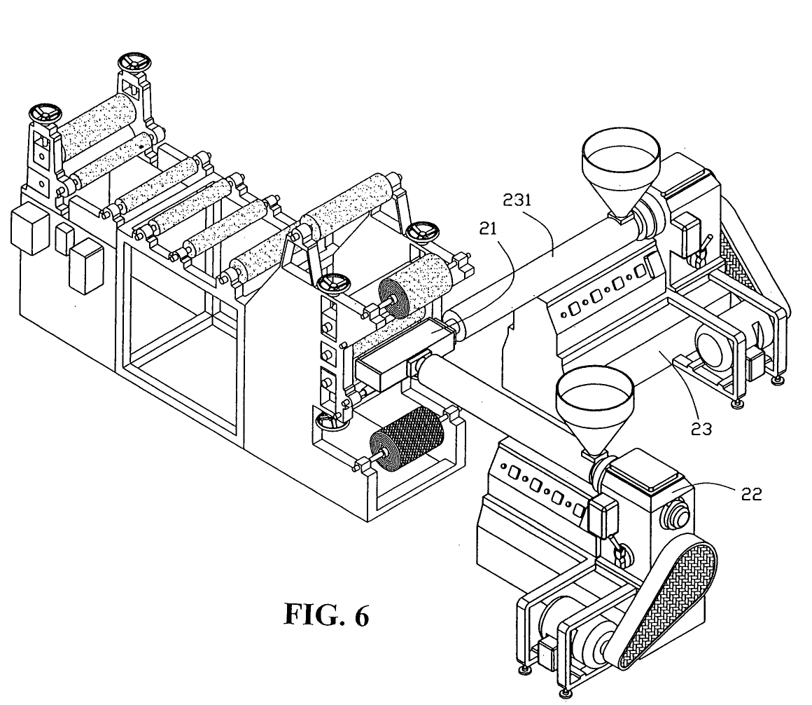

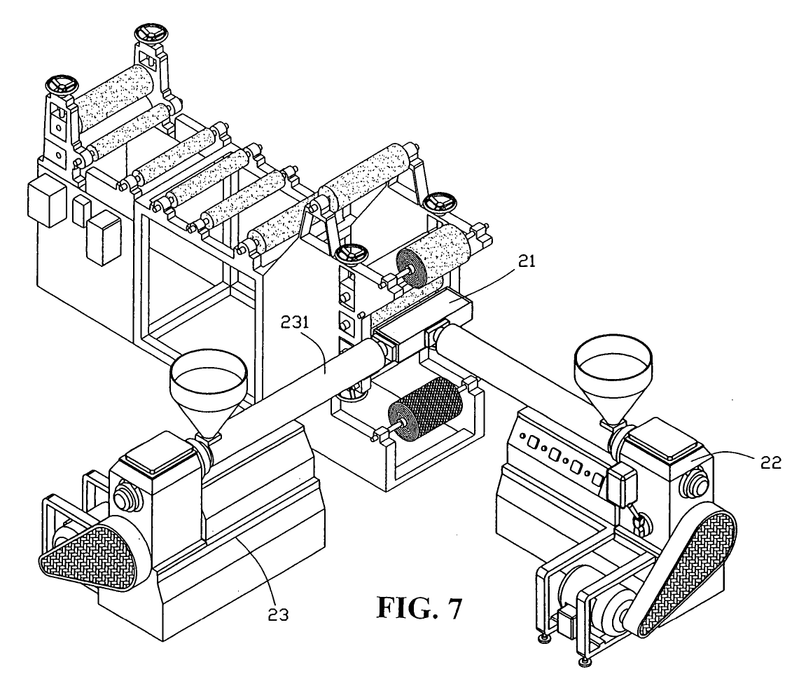

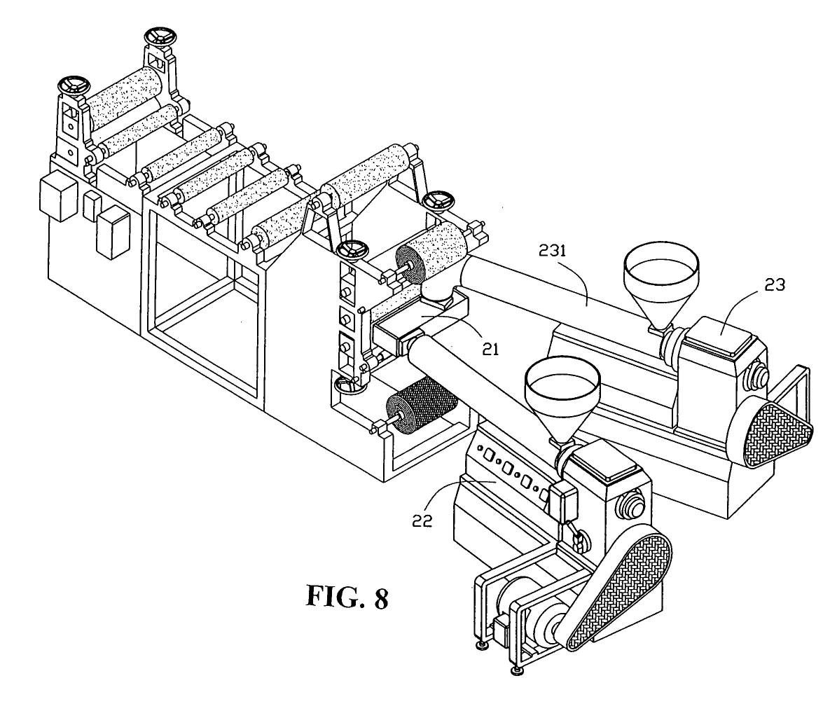

Now referring to FIGS. 6, 7 and 8, the heating guide pipe (231) of the second extruder (23) is connected to the right, left or above the heating die (21) depending on the density of the thermoplastic materials to be extruded in conjunction with the first extruder (22).

It will be understood that each of the elements described above, or two or more together may also find a useful application in other types of methods differing from the type described above.

While certain novel features of his invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An extruding system for the production of web bonded plastic sheet in bi-density construction, essentially comprised of a first extruder and a second extruder adapted to a heating die;
thermoplastic materials of different densities being delivered into the heating die through their respective heating guide pipes; an upper shaft rod and a lower shaft rod to respectively take up an upper web and a lower web being pivoted to the front of a rolling compressor; thermo-plastic materials in melting status being bonded to the webs on both sides and compressed into a web faced plastic sheet in bi-density construction.

2. An extruding system for the production of web bonded plastic sheet in bi-density construction as claimed in claim 1, wherein, the heating guide pipe of the second extruder is connected to the right of the heating die for delivering thermo-plastic materials of different densities at the same time in conjunction with the first extruder.

3. An extruding system for the production of web bonded plastic sheet in bi-density construction as claimed in claim 1, wherein, the heating guide pipe of the second extruder is connected to the left of the heating die for delivering thermo-plastic materials of different densities at the same time in conjunction with the first extruder.

4. An extruding system for the production of web bonded plastic sheet in bi-density construction as claimed in claim 1, wherein, the heating guide pipe of the second extruder is connected to where above the heating die for delivering thermoplastic materials of different densities at the same time in conjunction with the first extruder.
